(19) United States
(12) Patent Application Publication
(10) Pub. No.: US 2026/0175091 A1
(43) Pub. Date: Jun. 25, 2026

(54) GOLF BALL

(71) Applicant: BRIDGESTONE SPORTS CO., LTD., Tokyo (JP)

(72) Inventors: Kae IIZUKA, Chichibushi (JP); Yusuke Tanaka, Chichibushi (JP); Katsunori Sato, Chichibushi (JP)

(73) Assignee: BRIDGESTONE SPORTS CO., LTD., Tokyo (JP)

(21) Appl. No.: 19/409,937

(22) Filed: Dec. 5, 2025

(30) Foreign Application Priority Data
Dec. 24, 2024 (JP) 2024-227555

(51) Int. Cl. A63B 37/00; C08K 5/098; C08K 5/14; C08K 5/378; C08L 9/00; C08L 23/00

(52) U.S. Cl. CPC A63B 37/0075; A63B 37/0021; A63B 37/0039; A63B 37/0051; A63B 37/0063; A63B 37/00921; C08K 5/098; C08K 5/14; C08K 5/378; C08L 9/00; C08L 23/00; A63B 2209/00; C08L 2201/08; C08L 2312/02

(57) ABSTRACT

A golf ball includes a core, an intermediate layer, and a cover, in which dimples and a land portion are formed on a cover surface, the core is formed of a rubber composition containing a base rubber and an specific organic peroxide, the land portion includes a large number of land portion pieces, one land portion piece has a shape having at least three vertexes, the land portion includes a land portion piece having a specific shape formed by connecting the land portion piece in point contact with another adjacent land portion piece at each of the vertexes, an outer peripheral edge of the land portion piece having the specific shape includes a plurality of edge elements, and a ratio of the number of land portion pieces having a unique shape in which all the edge elements are formed in a predetermined curve is adjusted within a predetermined range.

### CROSS-REFERENCE TO RELATED APPLICATIONS

This non-provisional application claims priority under 35 U.S.C. § 119 (a) on Patent Application No. 2024-227555 filed in Japan on Dec. 24, 2024, the entire contents of which are hereby incorporated by reference.

### TECHNICAL FIELD

The present invention relates to a multi-piece solid golf ball having a structure of at least three layers including a core, a cover, and at least one intermediate layer sandwiched between the core and the cover.

### BACKGROUND ART

Recently, two-piece solid golf balls and three-piece solid golf balls have been mainly used as golf balls. These golf balls usually have a structure in which a core of a rubber composition is encased in a single-layer or multi-layer cover made of various resin materials. The core occupies most of a volume of the golf ball, and has a large influence on various ball properties such as rebound, feel at impact, and durability. Recently, various techniques have been proposed in which a unique core hardness gradient is realized by appropriately adjusting a cross-sectional hardness of the core, and a distance is improved by optimizing spin characteristics on full shots with a driver or an iron.

In a core formulation, a type and compounding amount of an organic peroxide selected as a crosslinking initiator of a base rubber such as polybutadiene may be appropriately selected in consideration of the type and amount of each component of other cores to be blended, desired core characteristics, molding conditions, and the like using a temperature of a one-minute half-life as an index. In a core obtained by heat-molding the rubber composition containing the organic peroxide, an inclined shape of a hardness from the center to an outside surface is unique, and the shape affects characteristics of the ball.

Examples of a technique focusing on the organic peroxide contained in the core include the following Patent Documents 1 to 3. Patent Document 1 proposes that two or more kinds of organic peroxides to be blended in a rubber composition forming a core are contained in the core, and a half-life ratio is defined, so that the core has a rebound of at least a certain level. Patent Document 2 proposes a technique in which a rubber composition contains two or more organic peroxides having one-minute half-life temperatures of 145 to 185° C. and 110 to 135° C. to improve the rebound and productivity of the core. Patent Document 3 proposes a technique in which a rubber composition contains two kinds of organic peroxides having different half-life temperatures, that is, (i) diacyl peroxides, (ii) dialkyl peroxides and/or peroxyketals, thereby reducing a spin rate of a ball including a core.

However, it is expected to further improve the rebound and durability of the core by designing the hardness so that the hardness gradient from the center to the surface of the core has a unique shape that is not conventional.

On the other hand, in a golf ball, it is well known that high rebound provided in the ball itself and reduction of air resistance during flight by dimples disposed on a ball surface are important in order for a struck ball to obtain a long distance, and various methods for arranging the dimples as densely and evenly as possible on the ball surface have been proposed for the purpose of reducing air resistance.

Typically, a design of the dimples of a golf ball takes an approach of disposing dimples of a predetermined shape or shapes on the ball surface. However, in such a method of disposing dimples having a predetermined shape, if a surface occupancy ratio of the dimples is very high, since the surface of the golf ball is spherical, it is difficult to evenly dispose the dimples, a place where gaps between the dimples are widened or narrowed occurs, and the gaps between the dimples are often uneven. If the gaps between the dimples are uneven, even if the dimples have a high surface occupancy ratio, an aerodynamic performance of the golf ball may be extremely poor.

For example, Patent Document 4 describes forming a ridge-shaped protrusion on the surface of a golf ball, which is completely different from a conventional concept of forming a large number of dimples on the surface of a golf ball. It is described that by forming the ridge-shaped protrusion in this way, an occupancy ratio of a portion without the protrusion corresponding to the surface occupancy ratio of the conventional dimples may be easily increased, and the aerodynamic performance may be improved.

In addition, Patent Document 5 proposes a golf ball including a plurality of dimples and a land portion surrounded by the plurality of dimples, in which the land portion has a shape having at least one vertex, the land portion is substantially in point contact with at least two adjacent land portions, and a surface area of the land portion is within a predetermined range. That is, in the golf ball, since the land portion has a specific shape, even if a surface occupancy ratio of the dimples is increased, the gaps between the dimples may be evenly maintained, the aerodynamic performance is improved, and the distance is increased.

However, there is a demand for a golf ball having a novel land portion shape and a dimple shape on the ball surface, which may improve the aerodynamic performance due to the dimple and may improve the distance more than the above proposed golf balls.

In addition, most of the dimple shapes so far are depressions obtained by drilling down a spherical surface such as a circular shape, an elliptical shape, a teardrop shape, and a polygonal shape, and have little novelty in appearance. Further, on a ball surface having such depressions, scratches derived from grooves of the club become conspicuous during golf play, and the ball appearance is not good.

### CITATION LIST

Patent Document 1: JP-A 2004-024851
Patent Document 2: JP-A 2012-132004
Patent Document 3: JP-A 2023-105273
Patent Document 4: JP-A 2004-105200
Patent Document 5: JP-A 2011-031043

### SUMMARY OF THE INVENTION

The present invention has been made in view of the above circumstances, and an object of the present invention is to provide a golf ball which has a unique hardness gradient from a center to a surface of a core, is novel in shapes of dimples and land portions formed on a ball surface, is excellent in initial velocity and low spin rate of the ball, and has a good ball appearance in which scratches on the ball surface are not noticeable.

As a result of intensive studies to achieve the above object, for a golf ball in which at least one intermediate layer is interposed between a core and a cover, the present inventors have completed the present invention by using the following components (a) to (d) as essential compounding components of a rubber composition of the core: (a) a base rubber, (b) an α,β-unsaturated carboxylic acid and/or a metal salt thereof as a co-crosslinking agent, (c) an organic peroxide having a one-minute half-life temperature of at least 165° C. as an organic peroxide, and (d) as an antioxidant, benzimidazole and/or a metal salt thereof represented by a specific formula. Further, for a ball surface shape, rather than focusing on dimples, the present inventors have completed the present invention by focusing on a shape of a land portion on an outside surface of the ball and optimizing the shape of the land portion. That is, the present inventors have found that it is possible to solve the above-described problems to be solved by the present invention by configuring a core formed of a rubber composition containing the above ingredients (a) to (d) as essential components, and in a shape of a land portion piece that has at least three vertexes and is the smallest unit of the land portion on the outside surface of the ball, the land portion includes a land portion piece having a specific shape formed by connecting the land portion piece substantially in point contact with another adjacent land portion piece at the vertex. Further, an outer peripheral edge of the land portion piece having the specific shape is configured from a plurality of edge elements, and a ratio of the number of land portion pieces having a unique shape in which all the edge elements are formed in a curve having a curvature of not more than 0.40 is at least 25% of a total number of land portion pieces constituting the land portion, and by combining these core formulations and ball surface shapes, the present inventors have completed the present invention.

Accordingly, the present invention provides a golf ball including
at least one intermediate layer interposed between a core and a cover, wherein a plurality of dimples and a land portion surrounded by the plurality of dimples are formed on a surface of the cover, and the core includes the following components (a) to (d):
(a) a base rubber,
(b) an α,β-unsaturated carboxylic acid and/or a metal salt thereof as a co-crosslinking agent,
(c) an organic peroxide, and
(d) as an antioxidant, benzimidazole and/or a metal salt thereof of the following general formula.

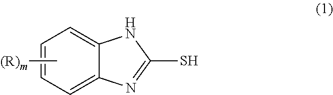

(In the formula, R is a hydrogen atom or a hydrocarbon group having 1 to 20 carbon atoms, m is an integer of 1 to 4, and if m is 2 or more, these values may be the same as or different from each other.)

Further, the component (c) is formed of a heat-molded product of a rubber composition containing only an organic peroxide having a one-minute half-life temperature of at least 165° C., the land portion is composed of a large number of land portion pieces, one land portion piece has a shape having at least three vertexes, the land portion includes a land portion piece having a specific shape formed by connecting the land portion piece substantially in point contact with another adjacent land portion piece at each of the vertexes, an outer peripheral edge of the land portion piece having the specific shape is composed of a plurality of edge elements, and a ratio of the number of land portion pieces having a unique shape in which all the edge elements are formed of a curve having a curvature of not more than 0.40 is at least 25% of a total number of land portion pieces constituting the land portion.

In a preferred embodiment of the golf ball according to the invention, the component (d) is 2-mercaptobenzimidazole.

In another preferred embodiment of the inventive golf ball, a compounding amount of the component (d) is at least 0.1 part by weight per 100 parts by weight of the component (a).

In yet another preferred embodiment, in a hardness profile of the core, when a JIS-C hardness at a core center is O, the JIS-C hardness at a position 10 mm from the core center is A, and the JIS-C hardness at a core surface is S, the following conditions are satisfied:

$$0 \leq A - O \leq 10$$

$$10 \leq S - A \leq 20$$

$$15 \leq S - O \leq 25 .$$

In still another preferred embodiment, the intermediate layer is formed of a resin composition containing the following (A) to (C):
(A) an ionic or nonionic olefin-unsaturated carboxylic acid copolymer and/or an ionic or nonionic olefin-unsaturated carboxylic acid-unsaturated carboxylic acid ester copolymer,
(B) an organic acid or a metal salt thereof, and
(C) a basic inorganic metal compound for neutralizing at least 80 mol % of acid groups in the components (A) and (B).

In a further preferred embodiment, the cover is formed of a resin composition containing at least one of a group of ionic or nonionic olefin-unsaturated carboxylic acid copolymers and ionic or nonionic olefin-unsaturated carboxylic acid-unsaturated carboxylic acid ester copolymers.

In a yet further preferred embodiment, in the copolymer of the intermediate layer, the unsaturated carboxylic acid is acrylic acid or methacrylic acid.

In a still further preferred embodiment, in the copolymer of the cover, the unsaturated carboxylic acid is acrylic acid or methacrylic acid.

In another preferred embodiment, a material hardness of the intermediate layer is from 45 to 60 on the Shore D hardness scale, and a material hardness of the cover is from 55 to 65 on the Shore D hardness scale.

In yet another preferred embodiment, the land portion is formed by connecting at least 4,000 curved edge elements.

In still another preferred embodiment, a ratio of the edge elements having a curvature of not more than 0.40 is at least 70% of curved edge elements forming the land portion.

In a further preferred embodiment, the dimples have a surface area occupancy ratio of from 80 to 95%.

### Advantageous Effects of the Invention

According to the golf ball of the present invention, the hardness gradient from the center to the surface of the core is unique, the shapes of the dimples and the land portions formed on the ball surface are novel, and a combination of these configurations makes the initial velocity and the low spin rate of the ball excellent, scratches on the ball surface become inconspicuous, and the appearance of the ball is good.

### BRIEF DESCRIPTION OF THE DRAWINGS

FIG. 1 is a schematic cross-sectional view showing an internal structure of a golf ball which is an example of the present invention.

FIG. 2 is a graph showing core hardness profiles in Examples 1 and 3 and Comparative Example 1.

FIG. 3 is a schematic view showing a ball surface of Examples 1 to 4, which are embodiments of the present invention.

FIG. 4A is a partially enlarged view showing the ball surface in FIG. 3, and FIG. 4B is a schematic view showing only a land portion in FIG. 4A.

FIG. 5 is a schematic view showing a golf ball of Comparative Example 2.

FIG. 6A is a partially enlarged view showing a ball surface in FIG. 5, and FIG. 6B is a schematic view showing only a land portion in FIG. 6A.

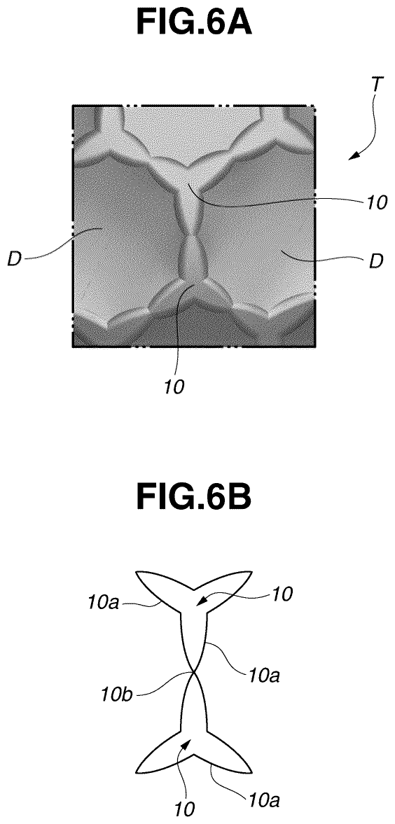

### DETAILED DESCRIPTION OF THE INVENTION

Hereinafter, the present invention is described in more detail.

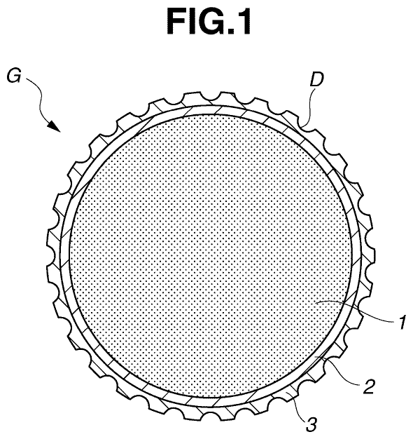

The golf ball of the present invention is a multi-piece solid golf ball having a structure from the inside of at least three layers including a core, an intermediate layer, and a cover. For example, an example thereof is shown in FIG. 1. A golf ball G shown in FIG. 1 has a single-layer core 1 and a single-layer cover 3, and further has a single-layer intermediate layer 2 between the core and the cover. The cover 3 is positioned at an outermost layer in the layer structure of the golf ball except for a coating layer. The core is formed in a single layer as shown in FIG. 1, and the cover is formed in a single layer as shown in FIG. 1. In addition, a single layer or a plurality of surrounding layers composed of resin may be formed between the intermediate layer and the core. A large number of dimples D are typically formed on a surface of the cover (outermost layer) 3 in order to improve aerodynamic properties of the ball. In addition, although not particularly illustrated, the coating layer is typically formed on the surface of the cover 3. Hereinafter, each of the above layers is described in detail.

The core is formed of a heat-molded product of a rubber composition containing the following components (a) to (d):
(a) a base rubber,
(b) an α,β-unsaturated carboxylic acid and/or a metal salt thereof as a co-crosslinking agent,
(c) an organic peroxide, and
(d) as an antioxidant, benzimidazole and/or a metal salt thereof represented by a specific formula.

The base rubber of the above component (a) is not particularly limited, although polybutadiene is particularly preferably used.

The polybutadiene suitably has at least 60%, preferably at least 80%, more preferably at least 90%, and most preferably at least 95% of a cis-1,4 bond in a polymer chain of the polybutadiene. If the cis-1,4 bond occupying a bond in a polybutadiene molecule is too small, a rebound may be reduced.

In addition, a content of a 1,2-vinyl bond contained in the polybutadiene is usually not more than 2%, preferably not more than 1.7%, and still more preferably not more than 1.5% in the polymer chain. If the content of the 1,2-vinyl bond is too large, the rebound may be reduced.

In the polybutadiene, (ML₁₊₄ (100° C.)) is preferably at least 20, and more preferably at least 30, and the upper limit thereof is preferably not more than 120, more preferably not more than 100, and still more preferably not more than 80.

A Mooney viscosity referred to in the present invention is an index of industrial viscosity (JIS K 6300) measured by a Mooney viscometer, which is one type of rotational plastometer, and ML₁₊₄ (100° C.) is used as a unit symbol. M represents the Mooney viscosity, L represents a large rotor (L type), 1+4 represents a preheating time of one minute and a rotation time of the rotor of four minutes, and measurement is performed under conditions of 100° C.

As the polybutadiene, a polybutadiene synthesized using a rare earth element-based catalyst or a Group VIII metal compound catalyst may be used.

In the base rubber, a polybutadiene rubber synthesized with a catalyst different from a lanthanum-series rare earth element compound may be blended. Styrene-butadiene rubber (SBR), natural rubber, polyisoprene rubber, ethylene propylene diene rubber (EPDM), and the like may be blended, and one kind thereof may be used alone, or two or more kinds thereof may be used in combination.

A proportion of the polybutadiene in the whole rubber is preferably at least 60 wt %, more preferably at least 70 wt %, and most preferably at least 90 wt %. Further, 100 wt % of the base rubber, that is, all of the base rubber, may be the polybutadiene.

Next, the component (b) is a co-crosslinking agent, and is an α,β-unsaturated carboxylic acid and/or a metal salt thereof. The number of carbon atoms of the unsaturated carboxylic acid is preferably from 3 to 8, and specific examples thereof include unsaturated carboxylic acids such as acrylic acid, methacrylic acid, maleic acid, and fumaric acid. Specific examples of a metal of the unsaturated carboxylic acid include zinc, sodium, magnesium, calcium, and aluminum, and zinc is particularly preferable. Therefore, zinc acrylate is most preferable as the co-crosslinking agent.

A compounding amount of the component (b) is preferably at least 10 parts by weight, more preferably at least 15 parts by weight, and still more preferably at least 20 parts by weight per 100 parts by weight of the base rubber of the component (a), and the upper limit is preferably not more than 65 parts by weight, more preferably not more than 60 parts by weight, and still more preferably not more than 55 parts by weight per 100 parts by weight of the base rubber. If the compounding amount is less than the above range, the golf ball becomes too soft and has poor rebound, and if the compounding amount is more than the above range, the golf ball becomes too hard, has a poor feel at impact, is fragile, and has inferior durability.

The co-crosslinking agent of the component (b) preferably has an average particle size of from 3 to 30 μm, more preferably from 5 to 25 μm, and still more preferably from 8 to 15 μm. If the average particle size of the co-crosslinking agent is less than 3 μm, the co-crosslinking agent is easily aggregated in the rubber composition, a reactivity between acrylic acids is increased, and a reactivity between the base rubbers is reduced, so that a rebound performance of the golf ball may not be sufficiently obtained. If the average particle size of the co-crosslinking agent exceeds 30 μm, the co-crosslinking agent particles become too large, and variations in characteristics of the resulting golf ball become large.

The component (c) is an organic peroxide, and in the present invention, only an organic peroxide having a one-minute half-life temperature of at least 165° C. is used. That is, in the present invention, the rubber composition does not contain any organic peroxide having a one-minute half-life temperature of lower than 165° C. Examples of such an organic peroxide include a dicumyl peroxide (“Percumyl D” manufactured by NOF Corporation), a 2,5-dimethyl-2,5-di(t-butylperoxy) hexane (“Perhexa 25B” manufactured by NOF Corporation), a di(2-t-butylperoxyisopropyl)benzene (“Perbutyl P” manufactured by NOF Corporation), a di-t-butyl peroxide (“Perbutyl D” manufactured by NOF Corporation), a t-butyl-cumyl peroxide (“Perbutyl C” manufactured by NOF Corporation), and a di-t-hexyl peroxide (“Perhexyl D” manufactured by NOF Corporation), and in particular, a dicumyl peroxide may be suitably used.

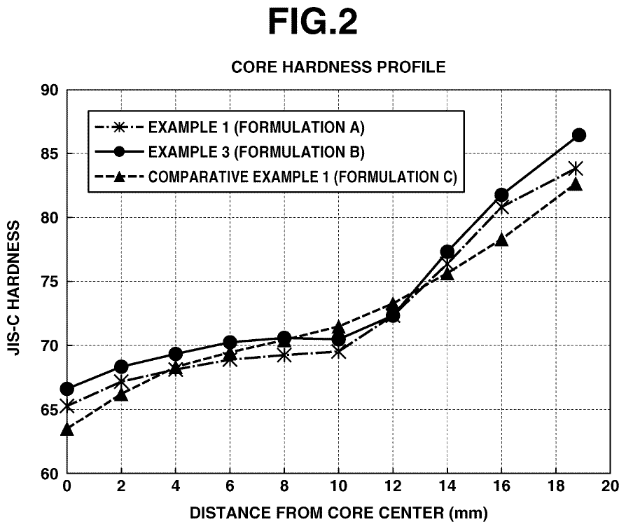

In the present invention, by using only an organic peroxide having a one-minute half-life temperature of at least 165° C. as the organic peroxide, a hardness gradient from a center of the core to a certain distance is not so large, and the hardness gradient from the certain distance to the outside of the core surface may be increased. For example, a hardness form is as shown in core hardness profiles of Examples 1 and 3 in FIG. 2. In addition, a hardness difference between the core center and the core outside surface may be made relatively small by blending the organic peroxide. As a result, initial velocities of the core and the ball may be improved, and a spin of the ball may be controlled.

The compounding amount of the component (c) is preferably at least 0.1 parts by weight, and more preferably at least 0.3 parts by weight per 100 parts by weight of the base rubber, and the upper limit thereof is preferably not more than 5 parts by weight, more preferably not more than 4 parts by weight, and still more preferably not more than 3 parts by weight per 100 parts by weight of the base rubber.

The component (d) is used as an antioxidant, and is a benzimidazole and/or a metal salt thereof represented by the following general formula.

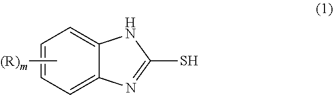

R in the formula (1) is a hydrogen atom or a hydrocarbon group having 1 to 20 carbon atoms, m is an integer of 1 to 4, and if m is 2 or more, Rs may be the same as or different from each other. Specific examples of the benzimidazole having the formula (1) include 2-mercaptobenzimidazole, 2-mercaptomethylbenzimidazole, and metal salts thereof, and the metal salt is preferably a zinc salt.

The compounding amount of the benzimidazole represented by the above specific formula and/or the metal salt thereof as the component (d) is preferably at least 0.1 parts by weight, and more preferably at least 0.3 parts by weight per 100 parts by weight of the base rubber, and the upper limit thereof is preferably not more than 5 parts by weight, and more preferably not more than 3 parts by weight per 100 parts by weight of the base rubber. By setting the compounding amount of the component (d) within the above range, the difference in hardness between the inside and the outside of the core may be increased. If the compounding amount of the component (d) is too small, a crosslinking reaction in a vicinity of the core surface is not efficiently promoted, a crosslinking density is not sufficiently increased, a hard layer having hardness is not sufficiently formed, the hardness difference between the core surface and the core center as an entire core is not sufficiently increased, and sufficient striking durability performance may not be obtained. On the other hand, even if the compounding amount of the component (d) is unnecessarily increased, an obtained effect does not exceed what would be achieved by the above-described preferable addition amount.

In addition to the components (a) to (d) described above, for example, various additives such as a filler, an organosulfur compound, water, and a processing aid may be blended as long as the effects of the present invention are not hindered.

As a filler, for example, zinc oxide, barium sulfate, calcium carbonate, or the like may be preferably used. These may be used singly, or two or more may be used in combination. The compounding amount of the filler may be preferably at least 1 part by weight, more preferably at least 3 parts by weight, and still more preferably at least 5 parts by weight per 100 parts by weight of the base rubber. An upper limit of the compounding amount may be preferably not more than 100 parts by weight, more preferably not more than 60 parts by weight, and still more preferably not more than 40 parts by weight per 100 parts by weight of the base rubber. If the compounding amount is too large or too small, it may not be possible to obtain an appropriate weight and a suitable rebound.

The organosulfur compound is not particularly limited, and examples thereof may include thiophenols, thionaphthols, diphenyl polysulfides, halogenated thiophenols, and metal salts thereof. Specific examples thereof may include zinc salts of pentachlorothiophenol, pentafluorothiophenol, pentabromothiophenol, parachlorothiophenol, and the like, diphenyl polysulfide having 2 to 4 sulfur atoms, dibenzyl polysulfide, dibenzoyl polysulfide, dibenzothiazoyl polysulfide, dithiobenzoyl polysulfide, and 2-thionaphthol. These may be used singly, or two or more may be used in combination. Among them, a zinc salt of pentachlorothiophenol and/or diphenyl disulfide may be preferably used.

The compounding amount of the organosulfur compound is preferably at least 0.05 parts by weight, more preferably at least 0.1 parts by weight, and still more preferably at least 0.2 parts by weight per 100 parts by weight of the base rubber, and the upper limit is preferably not more than 3 parts by weight, more preferably not more than 2 parts by weight, and still more preferably not more than 1 part by weight per 100 parts by weight of the base rubber. If the compounding amount of the organosulfur compound is too large, a hardness of the heat-molded product of the rubber composition may become too soft, whereas if the compounding amount is too small, the rebound may not be expected to be improved.

As the processing aid, a higher fatty acid, a metal salt thereof, or the like may be suitably used. Examples of the higher fatty acid include stearic acid, palmitic acid, oleic acid, linoleic acid, linolenic acid, and myristic acid, and stearic acid is particularly preferable. Examples of the metal salt of the higher fatty acid include a lithium salt, a sodium salt, a potassium salt, a copper salt, a magnesium salt, a calcium salt, a strontium salt, a barium salt, a tin salt, a cobalt salt, a nickel salt, a zinc salt, and an aluminum salt, and in particular, zinc stearate is suitably used. The compounding amount of the processing aid may be preferably at least 1 part by weight, more preferably at least 3 parts by weight, and still more preferably at least 5 parts by weight per 100 parts by weight of the base rubber. An upper limit of the compounding amount is preferably not more than 20 parts by weight, more preferably not more than 15 parts by weight, and still more preferably not more than 10 parts by weight per 100 parts by weight of the base rubber. If the compounding amount is too large, sufficient hardness and rebound may not be obtained, and if the compounding amount is too small, an additive chemical is not sufficiently dispersed, and expected physical properties may not be obtained. Although not particularly limited, examples of the method for adding the processing aid include a method in which the processing aid is put into a mixer simultaneously with other chemicals, a method in which the processing aid is added in advance by mixing with other chemicals such as the component (b), a method in which the processing aid is added by coating surfaces of other chemicals such as the component (b), and a method in which a masterbatch is prepared in advance together with the component (a) and added.

In the present invention, a specific antioxidant is used as the component (d), but an antioxidant different from the component (d) may be contained. Specific examples thereof include hindered phenol-based antioxidants such as 2,6-di-tert-butyl-4-methylphenol, 2,6-di-tert-butyl-4-ethylphenol, pentaerythritol tetrakis [3-(3,5-di-tert-butyl-4-hydroxyphenyl) propionate], 1,3,5-tris(3′,5′-di-t-butyl-4-hydroxybenzyl) isocyanuric acid, and the like. Commercially available products that may be used include Nocrac 200 and Nocrac M-17 (manufactured by Ouchi Shinko Chemical Industrial Co., Ltd.), IRGANOX 1010 (manufactured by BASF), ADK STAB AO-20 (manufactured by ADEKA Corporation), and the like. These may be used singly, or two or more may be used in combination. The compounding amount of the antioxidant is not particularly limited, although the compounding amount is preferably at least 0.05 parts by weight, and more preferably at least 0.1 parts by weight per 100 parts by weight of the base rubber, and the upper limit is preferably not more than 1.0 part by weight, more preferably not more than 0.7 parts by weight, and still more preferably not more than 0.4 parts by weight per 100 parts by weight of the base rubber. If the compounding amount is too large or too small, a suitable core hardness gradient cannot be obtained, and it may not be possible to obtain suitable rebound, durability, and a spin rate-lowering effect on full shots.

The core is a vulcanized molded product obtained by vulcanizing and hardening the rubber composition. The core may be a single layer or a plurality of layers, and the vulcanized molded product may be used for all or a part of the single layer or the multi-layer core. For example, the core, which is the vulcanized molded product, may be manufactured by intensively mixing the rubber composition using a mixing apparatus such as a Banbury mixer or a roll mill, subsequently compression molding or injection molding the mixture using a core mold, and curing the resulting molded body by appropriately heating it at a temperature sufficient for the organic peroxide or the co-crosslinking agent to act, such as at a temperature of approximately 100 to 200° C., and for 10 to 40 minutes.

A diameter of the core is not particularly limited and depends on the layer structure of the golf ball to be manufactured, although the diameter is preferably at least 33 mm, and more preferably at least 35 mm, and the upper limit is preferably not more than 41 mm, and more preferably not more than 40 mm. If the diameter of the core deviates from this range, the initial velocity of the ball may be low or appropriate spin characteristics may not be obtained.

In the core hardness profile, it is preferable that the hardness stays mostly the same or increases from the center of the core toward the surface, and is not decreased. When a JIS-C hardness at the center of the core is defined as O, the JIS-C hardness at a position 10 mm from the center of the core is defined as A, and the JIS-C hardness at the surface of the core is defined as S, the following three conditions are preferably satisfied:

$$0 \leq A - O \leq 10$$

$$10 \leq S - A \leq 20$$

$$15 \leq S - O \leq 25 .$$

If the value of the hardness difference in each of the above conditions is smaller than the lower limit, a spin rate-lowering effect on shots with a driver (W #1) may be insufficient and a flight distance may not be increased. On the other hand, if the value of the hardness difference in each of the above conditions is larger than the upper limit, the initial velocity of the ball when the golf ball is actually struck is lowered and the flight distance is not increased, or a durability to cracking on repeated impact may worsen. Here, center hardness means hardness measured at the center of a cross-section obtained by cutting the core in half (so as to pass through the center), and surface hardness means hardness measured at the surface (spherical surface) of the core. The JIS-C hardness means a hardness measured by a spring-type durometer (JIS-C type) specified in JIS K 6301-1975.

The center hardness O of the core is preferably at least 45, and more preferably at least 50 in JIS-C hardness, and the upper limit is preferably not more than 70, and more preferably not more than 65. If the center hardness of the core deviates from the above range, a feel at impact may worsen or the durability may be deteriorated. If the center hardness is less than the above range, insufficient vulcanization of the core may be considered, and it may be difficult to obtain a desired ball performance.

The JIS-C hardness of a position hardness A at a position 10 mm from the center of the core is preferably at least 50, and more preferably at least 52, and the upper limit thereof is preferably not more than 65, and more preferably not more than 60. If the position hardness of the core deviates from the above range, the feel at impact may be deteriorated.

A surface hardness S of the core is preferably at least 60, and more preferably at least 65 in JIS-C hardness, and the upper limit is preferably not more than 90, and more preferably not more than 85. If the surface hardness of the core is lower than the above range, the rebound of the ball becomes low, it becomes difficult to sufficiently obtain the spin rate-lowering effect, and as a result, a sufficient distance may not be obtained. If the surface hardness of the core is higher than the above range, the feel at impact becomes too hard, and the durability to cracking on repeated impact may worsen.

Regarding the hardness profiles of the core in the present invention satisfying the above three conditions, for example, as shown in FIG. 2 (Examples 1 and 3), the hardness gradient from a distance 10 mm away from the center of the core as a starting point to the surface of the core increases.

At least one intermediate layer is provided between the core and the cover (outermost layer).

A resin material of the intermediate layer is not particularly limited, although known thermoplastic resin materials such as various ionomer resins used for golf balls may be used.

In addition, it is particularly preferable to use a highly neutralized ionomer material as the intermediate layer material in order to further realize a low spin rate of the ball. Specifically, it is preferable to use a material in which a resin composition contains the following components (A) to (C):
(A) an ionic or nonionic olefin-unsaturated carboxylic acid copolymer and/or an ionic or nonionic olefin-unsaturated carboxylic acid-unsaturated carboxylic acid ester copolymer,
(B) an organic acid or a metal salt thereof, and
(C) a basic inorganic metal compound for neutralizing at least 80 mol % of acid groups in the components (A) and (B).

As the olefin component of the component (A), the number of carbon atoms is preferably 2 to 6, and ethylene is particularly preferable. As the unsaturated carboxylic acid of the component (A), either acrylic acid or methacrylic acid is preferably employed. As the unsaturated carboxylic acid ester of the component (A), a lower alkyl ester is preferable, and butyl acrylate (butyl n-acrylate, butyl acrylate) is particularly preferable.

Specific examples of the component (A) include the “IOTEK” series manufactured by Exxon Mobil Corporation, the “Himilan” series manufactured by Dow-Mitsui Polychemicals Co., Ltd., and the “SURLYN” series of ionomer resins manufactured by The Dow Chemical Company.

The component (B) is an organic acid and a metal salt thereof, and the type thereof is not particularly limited, although it is particularly preferable to employ a metal stearate or a metal oleate. Examples of the metal stearate include magnesium stearate, calcium stearate, zinc stearate, and sodium stearate. Among these examples, magnesium stearate is particularly preferably used.

The component (C) is a basic inorganic metal compound, and examples of the type thereof include Na⁺, K⁺, Li⁺, Zn²⁺, Ca²⁺, Mg²⁺, Cu²⁺, and Co²⁺. Na⁺, Zn²⁺, Ca²⁺, and Mg²⁺ are particularly preferable, and Mg²⁺ is still more preferable. These metal salts may be introduced into the resin composition using formate, acetate, nitrate, carbonate, hydrogen carbonate, oxide, hydroxide, or the like.

The component (C) neutralizes at least 80 mol % of the acid groups in the components (A) and (B), and is blended in an appropriate amount to neutralize preferably at least 83 mol % of the acid groups, and more preferably at least 85 mol % of the acid groups. A specific compounding amount is from 0.5 to 4.0 parts by weight and preferably from 0.75 to 3.5 parts by weight per 100 parts by weight of the resin of the component (A) and the component (B).

In the resin composition containing the above components (A) to (C), arbitrary additives may be appropriately blended according to the application, and various additives such as a pigment, a dispersant, an antioxidant, an ultraviolet absorber, and a light stabilizer may be added.

As a method for preparing the resin composition containing the above components (A) to (C), a known kneading method may be employed, and although not particularly limited, a method of kneading using an extruder may be suitably employed. In this case, as the extruder, either a single screw extruder or a twin screw extruder may be used, but a twin screw extruder having a higher kneading effect may be suitably used. A connection-type extruder in which a plurality of extruders are connected may also be used, and examples thereof include a two-stage connection-type such as a single screw extruder-to-twin screw extruder and a twin screw extruder-to-twin screw extruder.

A material hardness of the intermediate layer may be preferably at least 45, and more preferably at least 48 on the Shore D hardness scale. Although not particularly limited, the upper limit thereof may be preferably not more than 60, and more preferably not more than 55.

A thickness of the intermediate layer is set to not more than 2.0 mm, preferably not more than 1.8 mm, and more preferably not more than 1.5 mm. The lower limit is not particularly limited, although the lower limit is preferably at least 0.8 mm, more preferably at least 1.0 mm, and still more preferably at least 1.2 mm. If the thickness of the intermediate layer deviates from the above numerical range, the spin rate-lowering effect on shots with a driver (W #1) becomes insufficient, and the flight distance may not be increased.

Next, the cover in the present invention will be described.

The resin material of the cover is not particularly limited, besides an ionomer resin or a highly neutralized resin material of the same type as or different types from those of the intermediate layer material described above, a polyurethane resin such as a thermoplastic polyurethane elastomer may be used as a chief material. In particular, the cover is preferably formed of a resin composition containing at least one of a group of ionic or nonionic olefin-unsaturated carboxylic acid copolymers and ionic or nonionic olefin-unsaturated carboxylic acid-unsaturated carboxylic acid ester copolymers.

The material hardness of the cover on the Shore D hardness scale may be preferably at least 55, and more preferably at least 58. Although not particularly limited, the upper limit thereof may be preferably not more than 65, and more preferably not more than 63.

A thickness of the cover is set to not more than 2.0 mm, preferably not more than 1.8 mm, and more preferably not more than 1.5 mm. The lower limit is not particularly limited, although the lower limit is preferably at least 0.8 mm, more preferably at least 1.0 mm, and still more preferably at least 1.2 mm. If the thickness of the cover deviates from the above numerical range, the spin rate-lowering effect on shots with a driver (W #1) becomes insufficient, and the flight distance may not be increased. If the thickness of the cover is too small, durability may deteriorate.

The manufacture of a golf ball in which the above-described core, intermediate layer, and cover (outermost layer) are formed as successive layers may be performed by a customary method such as a known injection molding process. For example, an intermediate layer material is injected around the core in an injection mold to obtain each layer-encased sphere, and then the cover material, which is the outermost layer, is injection molded to obtain the golf ball. In addition, as each encasing layer, it is also possible to produce the golf ball by preparing two half-cups pre-molded into hemispherical shapes, enclosing the layer-encased sphere within the two half-cups, and molding the encased spheres under applied heat and pressure.

In the present invention, the surface of the cover (outermost layer) includes a plurality of dimples and a land portion surrounded by the plurality of dimples. The land portion means a portion where no dimple is formed on the surface of the outermost layer. A boundary line between the land portion and the dimple corresponds to an outer peripheral edge of the land portion or an outer peripheral edge of the dimple, and is referred to as an edge portion or an edge element in the present invention.

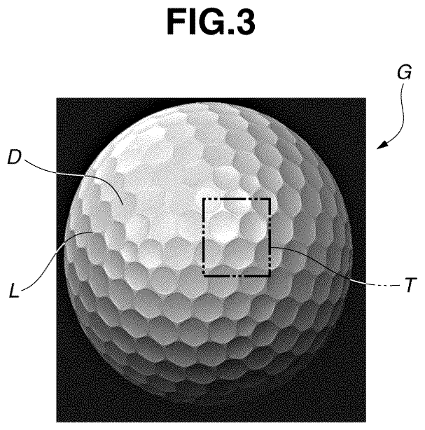

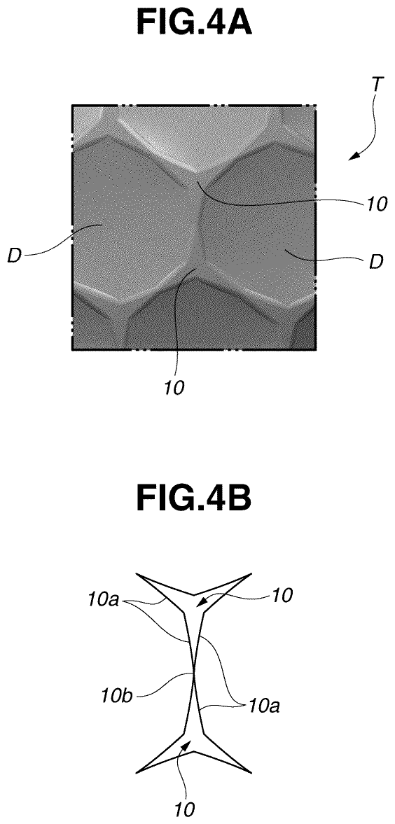

The land portion includes a large number of land portion pieces. For example, FIG. 3 shows a plan view of a golf ball of Examples 1 to 3 according to an embodiment of the present invention. The golf ball has a large number of dimples D and land portions L. An enlarged view of an area T among the dimples D and the land portions L is shown in FIG. 4A, and a large number of land portion pieces 10 that are minimum units of the land portions L are formed. That is, six land portion pieces 10 are formed around one dimple D. As a result, the outer peripheral edge of the dimple D has a substantially dodecagonal shape. Sides between vertexes of the substantially dodecagonal polygon are not straight but curved.

As shown in FIGS. 4A and 4B, the land portion piece 10 has a trifurcated shape (a shape radially extending in three directions and separated by about 120 degrees), and each extending portion extending radially is gradually narrowed outward and has a pointed tip. This pointed portion is a vertex 1a, that is, one land portion piece 10 has three vertexes 10b, and is substantially in point contact with another land portion piece adjacent to the land portion piece at the vertex. The outer peripheral edge of one land portion piece 10 includes six edge elements 10a. In other words, the six edge elements are connected to each other, so that the land portion piece has the above-described trifurcated shape.

The shape of the land portion piece is not limited to the above-described trifurcated shape, and may be, for example, a Y shape, a T shape, a star shape, or the like, as long as the land portion piece has a shape having at least three vertexes, and has a specific shape that is substantially in point contact with and connected to another adjacent land portion piece at each of the vertexes. The land portion piece is not limited to only one type, and two or more types having different sizes or shapes may be used.

In the present invention, in the land portion piece, the edge element is preferably formed by a curve having a curvature of not more than 0.40. In the present invention, by using a curve having a curvature of not more than 0.40 as the edge element, novelty of a ball surface (appearance) and an optimum shape of aerodynamic performance are configured, and a distance is increased. The curvature of the edge element is preferably not more than 0.40, more preferably not more than 0.35, and still more preferably not more than 0.30. In this way, the curvature of each edge element is set to be small as described above in order to avoid a shape creating air resistance as much as possible with respect to a shape of an inner peripheral side surface (edge) of the dimple.

A ratio of the number of land portion pieces in which all the edge elements are formed by a curve having a curvature of not more than 0.40 is at least 25%, preferably at least 30%, more preferably at least 40%, and still more preferably at least 50% of a total number of land portion pieces constituting the land portion.

In the present invention, it is preferable that the number of curves to be edge elements is at least 4,000 as a whole. A ratio of the edge elements having a curvature of not more than 0.40 in the curved edge elements forming the land portion is preferably at least 70%, and more preferably at least 75%. By increasing a ratio of the curves having not more than the predetermined curvature in this manner, it is possible to reduce air resistance on the ball surface and to further increase the flight distance.

In this way, land portion pieces having a predetermined shape are disposed on the golf ball, the dimples on the ball surface are designed, and a plurality of land portion pieces are arranged such that the adjacent land portion pieces are substantially in point contact with each other, whereby gaps between the dimples may be made even, even if a ratio of the surface of the dimple to the virtual spherical surface of the golf ball, that is, a surface occupancy ratio of the dimples, is increased. Therefore, the aerodynamic performance of the golf ball is significantly improved, and a longer distance may be obtained. In addition, the surface occupancy ratio of the dimples may be easily controlled by changing the shape of the land portion piece.

The surface occupancy ratio of the dimples is preferably at least 80%, and more preferably at least 85%. By setting the surface occupancy ratio of the dimples to at least 80%, air resistance may be reduced. On the other hand, the upper limit of the surface occupancy ratio of the dimples is preferably not more than 95%. Specifically, the surface occupancy ratio of the dimples means a ratio (SR value) of a total dimple surface area defined by a surface edge of a flat plane circumscribed by an edge of the dimple to a spherical surface area of the ball assuming that no dimples exist.

The total number of land portion pieces formed on the surface of the golf ball is preferably at least 434, and more preferably at least 540. On the other hand, a total number of land portions 12 is preferably not more than 864, and more preferably not more than 756. By setting the total number of land portion pieces within such a range, the surface occupancy ratio of dimples on the ball surface may be designed within the above preferable range.

A total number of dimples formed on the ball surface is usually 200 to 500, although the total number is determined according to the total number of land portion pieces and a relationship between the land portions and the dimples. For example, in a case where the total number of land portion pieces is 434, if one dimple is formed by six land portion pieces, the total number of dimples is 218. Similarly, if one dimple is formed by six land portion pieces, in a case where the total number of land portion pieces is 540, the total number of dimples is 272, in a case where the total number of land portion pieces is 756, the total number of dimples is 380, and in a case where the total number of land portion pieces is 864, the total number of dimples is 434.

As for the shape of the dimples, usually, due to the disposition of the land portion pieces described above, non-circular dimples are disposed in most of the land portion pieces, although circular dimples may also be formed. In the case of having circular dimples, the number of circular dimples is preferably at least 2, and more preferably at least 10, and the upper limit is preferably not more than 30. A ratio of the circular dimples with respect to the total number of dimples is preferably not more than 10%, and more preferably not more than 5%. In this way, the dimples formed on the surface of the golf ball according to the present invention are not limited to non-circular dimples, and may also include circular dimples.

A total volume of the dimples means a sum of volumes of the individual dimples formed below the flat plane circumscribed by the edge of the dimple in all the dimples formed on one ball. The total dimple volume is not particularly limited, although the total dimple volume is preferably from 300 to 600 mm³. By adjusting the total dimple volume to the above range, it is possible to optimize and stabilize a ball trajectory on shots with a driver (W #1) and to obtain an intended distance.

The golf ball of the present invention may be manufactured with a mold. In order to produce such a mold, 3DCAD or CAM may be used, and a method of directly three-dimensionally cutting an entire surface shape or a method of directly three-dimensionally cutting a cavity portion of the mold may be used for a reversing master mold. Finishing (trimming) may be facilitated by designing the mold such that a parting line of the mold passes through the land portion of the golf ball surface. In order to uniformly spread the land portion pieces on the spherical surface of the golf ball, it is preferable to use a disposition method of a polyhedron—for example, a 20-hedron, 12-hedron, or 8-hedron—three-fold symmetry, five-fold symmetry, or the like.

### EXAMPLES

Hereinafter, the present invention is specifically described with reference to Examples and Comparative Examples, but the present invention is not limited to the following Examples.

### Examples 1 to 4 and Comparative Examples 1 and 2

A core composition is adjusted by blending a rubber containing polybutadiene as a principal component shown in the following Table 1, then vulcanization is performed at 155° C. for 20 minutes, and a core having a diameter of 37.6 mm is produced through a core surface polishing process.

TABLE 1

| Core formulation (pbw) | | A | B | C |
|---|---|---|---|---|
| (a) | Polybutadiene rubber | 100 | 100 | 100 |
| (b) | Zinc acrylate | 25.0 | 30.0 | 25.0 |
| (b) | Zinc stearate | 2.0 | | 2.0 |
| (c) | Organic peroxide (1) | 1.0 | 1.0 | 0.6 |
| (c) | Organic peroxide (2) | | | 1.2 |
| (d) | Antioxidant | 0.3 | 0.3 | 0.3 |
| — | Zinc oxide | 28.0 | 25.0 | 28.0 |
| — | Water | | 0.4 | |
| — | Organosulfur compound | 0.4 | 1.0 | 1.0 |

Details of the above core formulation are as follows.
Polybutadiene rubber: Trade name “BR 730” (manufactured by ENEOS Materials Corporation)
Zinc acrylate: Trade name “ZN-DA85S” (manufactured by Nippon Shokubai Co., Ltd.)
Zinc stearate: Trade name “Zinc stearate GP” (manufactured by NOF Corporation)
Organic peroxide (1): Dicumyl peroxide, trade name “Percumyl D” (manufactured by NOF Corporation), one-minute half-life temperature 175.2° C.
Organic peroxide (2): Mixture of 1,1-di(t-butylperoxy)cyclohexane and silica, trade name “Perhexa C-40” (manufactured by NOF Corporation), one-minute half-life temperature 153.8° C.
Antioxidant: Trade name “Nocrac MB” (manufactured by Ouchi Shinko Chemical Industrial Co., Ltd.)
Zinc oxide: Trade name “Zinc Oxide Grade 3” (manufactured by Sakai Chemical Industry Co., Ltd.)
Water: Distilled water
Zinc salt of pentachlorothiophenol: Manufactured by Zhejiang Shou & Fu Chemtrade Co., Ltd.

Next, using an injection mold, injection molding is performed with a resin material D or E of an intermediate layer shown in Table 2 around the core surface to form an intermediate layer having a thickness of 1.30 mm and a hardness of 50 on the Shore D hardness scale. Subsequently, using an injection mold having a large number of dimple-forming protrusions in a cavity, injection molding is performed with a resin material F of a cover (outermost layer) shown in Table 2 around an intermediate layer-encased sphere to form a cover having a thickness of 1.25 mm and a hardness of 62 on the Shore D hardness scale.

TABLE 2

| Resin formulation (pbw) | D | E | F |
|---|---|---|---|
| Himilan AM7318 | | | 50 |
| Himilan AM7327 | | | 50 |
| AN4319 | 100 | | |
| HPF 1000 | | 100 | |
| Magnesium stearate | 70 | | |
| Magnesium oxide | 1.9 | | |
| Titanium oxide | | | 4 |

Details of the blending components in the above table are as follows.
“AM7318” ionomer resin, manufactured by Dow-Mitsui Polychemicals Co., Ltd.
“AM7327” ionomer resin, manufactured by Dow-Mitsui Polychemicals Co., Ltd.
“AN4319” NUCREL™ manufactured by Dow-Mitsui Polychemicals Co., Ltd.
“HPF 1000”, manufactured by The Dow Chemical Company
“Titanium oxide”, manufactured by Sakai Chemical Industry Co., Ltd.

### Dimples and Land Portion of Each Example

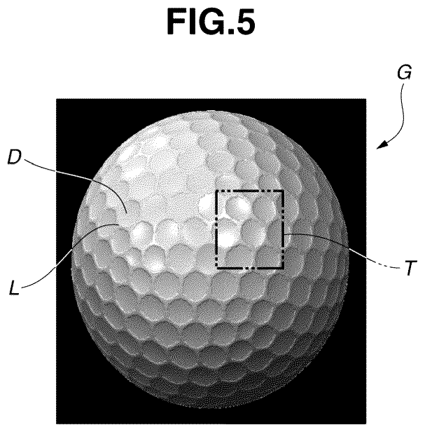

As described above, by injecting the resin material of the cover using the injection mold having a large number of dimple-forming protrusions in the cavity, dimples and land portion pieces having a predetermined shape are formed on the surface of the cover. The details are shown in Table 3. In Table 3, a photograph of dimple No. 1 is shown in FIG. 3, and a photograph of No. 2 is shown in FIG. 5.

Conditions and methods for measuring a radius of curvature of the edge element of the land portion piece formed on the ball surface of each example are as follows.

At least six curves (edge elements) constituting the shape of the land portion piece on the ball surface are analyzed to calculate the curvature of each curve. Each curve constituting the shape of the land portion piece is equally divided into sections by 20 plots, the curvature of the curve is calculated in each section, and a maximum curvature and a minimum curvature per curve are calculated. Regarding the circular dimple, the land portions (land portion pieces) sandwiched between the dimples are individually designated, and the maximum curvature and the minimum curvature of an arc of each dimple are calculated. This curvature is calculated using a method of analyzing each curve on the drawing by a computer or a method using an equation of a curve constituting the land portion piece based on the measured dimple shape. The number of curves having a maximum curvature of not more than 0.4 is counted as the curvature of the curve, and a ratio of the number of such curves to the total number of curves constituting the land portion piece is calculated.

### [Core Hardness Profile]

The core surface is spherical, but an indenter of a durometer is set substantially perpendicular to the spherical core surface, and a core surface hardness S is measured with JIS-C hardness according to the JIS K 6301-1975 standard. A center hardness O of the core and a cross-section hardness A at a position 10 mm away from the center of the core are measured by cutting the core into hemispheres to obtain a flat cross-section, and pressing the indenter of the durometer perpendicularly against the measurement portion. The hardnesses are indicated by JIS-C hardness values. The measured values are shown in Table 3.

FIG. 2 shows a graph of core hardness profiles for Examples 1 and 3 and Comparative Example 1.

### [Evaluation of Flight]

A flight of the golf ball in each example is evaluated as follows.

A driver is mounted on a golf swing robot, an initial velocity, a spin rate, and a flight distance traveled (carry and total) by a ball when struck at head speeds (HS) of 45 m/s and 40 m/s are measured, and the results are shown in Table 3. The club used is a “Tour B XD-5 Driver/loft angle 9.5° (2017 model)” manufactured by Bridgestone Sports Co., Ltd.

TABLE 3

| | | | | | | | Comparative | | |
|---|---|---|---|---|---|---|---|---|---|
| | | | | Example | | | Example | | Example |
| | | | | 1 | 2 | 3 | 1 | 2 | 4 |
| Internal | Core | Formulation | | A | A | B | C | B | A |
| structure | Intermediate layer | Material | | E | D | E | E | D | E |
| of ball | Cover | Material | | F | F | F | F | F | F |
| | Core hardness profile | 10 mm to center | | 4.2 | 4.2 | 3.9 | 7.9 | 3.9 | 4.2 |
| | (JIS-C) | Surface to 10 mm | | 14.2 | 14.2 | 15.9 | 11.2 | 15.9 | 14.2 |
| | | Surface to center | | 18.5 | 18.5 | 19.8 | 19.1 | 19.8 | 18.5 |
| Dimples | Type | | | No. 1 | No. 1 | No. 1 | No. 1 | No. 2 | No. 1 |
| | Surface area occupancy ratio: SR (%) | | | 92 | 92 | 92 | 92 | 90 | 92 |
| | Quantity | | | 338 | 338 | 338 | 338 | 338 | 338 |
| | Number of circular dimples | | | 14 | 14 | 14 | 14 | 8 | 14 |
| | Number of non-circular dimples | | | 324 | 324 | 324 | 324 | 330 | 324 |
| | Ratio of circular dimples (%) | | | 4.1 | 4.1 | 4.1 | 4.1 | 2.4 | 4.1 |
| Land | Each | Total number | | 816 | 816 | 816 | 816 | 816 | 816 |
| portion | land | Land portion pieces | Quantity | 456 | 456 | 456 | 456 | 192 | 256 |
| | portion | with all edge elements | Ratio (%) | 55.9 | 55.9 | 55.9 | 55.9 | 23.5 | 31.4 |
| | piece | having a curvature of | | | | | | | |
| | | not more than 0.40 | | | | | | | |

| | | | | | | | | |
|---|---|---|---|---|---|---|---|---|
| | Entire | Total number of curves | 4,896 | 4,896 | 4,896 | 4,896 | 4,896 | 4,896 |
| | ball | Total number of curves with | 3,786 | 3,786 | 3,786 | 3,786 | 3,402 | 3,586 |
| | surface | a curvature of not more than 0.40 | | | | | | |
| | | Ratio of curves with a curvature | 77.3 | 77.3 | 77.3 | 77.3 | 69.5 | 73.2 |
| | | of not more than 0.40 (%) | | | | | | |
| Flight | W#1 | Initial velocity (m/s) | 66.4 | 66.3 | 66.5 | 66.2 | 66.4 | 66.3 |
| | HS | Spin rate (rpm) | 2,663 | 2,700 | 2,717 | 2,629 | 2,700 | 2,676 |
| | 45 m/s | Carry (m) | 218.2 | 221.2 | 217.9 | 216.2 | 219.1 | 218.0 |
| | | Total (m) | 233.1 | 232.0 | 232.8 | 230.5 | 229.9 | 232.3 |
| | W#1 | Initial velocity (m/s) | 59.3 | 58.8 | 59.5 | 59.2 | 59.4 | 59.3 |
| | HS | Spin rate (rpm) | 2,934 | 2,940 | 3,018 | 2,896 | 2,969 | 2,979 |
| | 40 m/s | Carry (m) | 193.4 | 195.2 | 192.8 | 193.0 | 193.1 | 194.0 |
| | | Total (m) | 203.3 | 203.9 | 203.0 | 200.4 | 200.9 | 203.0 |

As shown in the results in Table 3, the golf balls of Comparative Examples 1 and 2 are inferior in the following respects to the golf balls according to the present invention (Examples).

In Comparative Example 1, an organic peroxide having a one-minute half-life temperature of less than 165° C. is contained in the core formulation, and the distance when the ball is struck by a driver (W #1) at head speeds of HS 40 m/s and HS 45 m/s is inferior to that in each Example.

In Comparative Example 2, the ball surface contains a unique land portion piece having a trifurcated shape in the land portion, but the ratio of the land portion pieces in which all the edge elements of the land portion are formed in a curve having a curvature of not more than 0.40 is very small, and the distance when the ball is struck with a driver (W #1) at head speeds of HS 40 m/s and HS 45 m/s is inferior to that in each Example.

Japanese Patent Application No. 2024-227555 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A golf ball comprising at least one intermediate layer interposed between a core and a cover, wherein a plurality of dimples and a land portion surrounded by the plurality of dimples are formed on a surface of the cover, and the core includes the following components (a) to (d):
(a) a base rubber,
(b) an α,β-unsaturated carboxylic acid and/or a metal salt thereof as a co-crosslinking agent,
(c) an organic peroxide, and
(d) as an antioxidant, benzimidazole and/or a metal salt thereof of the following general formula: 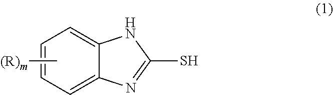
(in the formula, R is a hydrogen atom or a hydrocarbon group having 1 to 20 carbon atoms, m is an integer of 1 to 4, and if m is 2 or more, these values may be the same as or different from each other),
the component (c) is formed of a heat-molded product of a rubber composition containing only an organic peroxide having a one-minute half-life temperature of at least 165° C., the land portion is composed of a large number of land portion pieces, one land portion piece has a shape having at least three vertexes, the land portion includes a land portion piece having a specific shape formed by connecting the land portion piece substantially in point contact with another adjacent land portion piece at each of the vertexes, an outer peripheral edge of the land portion piece having the specific shape is composed of a plurality of edge elements, and a ratio of the number of land portion pieces having a unique shape in which all the edge elements are formed of a curve having a curvature of not more than 0.40 is at least 25% of a total number of land portion pieces constituting the land portion.

2. The golf ball of claim 1, wherein the component (d) is 2-mercaptobenzimidazole.

3. The golf ball of claim 1, wherein a compounding amount of the component (d) is at least 0.1 parts by weight per 100 parts by weight of the component (a).

4. The golf ball of claim 1, wherein in a hardness profile of the core, when a JIS-C hardness at a core center is O, the JIS-C hardness at a position 10 mm from the core center is A, and the JIS-C hardness at a core surface is S, the following three conditions are satisfied:
$$0 \leq A - O \leq 10$$
$$10 \leq S - A \leq 20$$
$$15 \leq S - O \leq 25 .$$

5. The golf ball of claim 1, wherein the intermediate layer is formed of a resin composition containing the following (A) to (C):
(A) an ionic or nonionic olefin-unsaturated carboxylic acid copolymer and/or an ionic or nonionic olefin-unsaturated carboxylic acid-unsaturated carboxylic acid ester copolymer,
(B) an organic acid or a metal salt thereof, and
(C) a basic inorganic metal compound for neutralizing at least 80 mol % of acid groups in the components (A) and (B).

6. The golf ball of claim 1, wherein the cover is formed of a resin composition containing at least one of a group of ionic or nonionic olefin-unsaturated carboxylic acid copolymers and ionic or nonionic olefin-unsaturated carboxylic acid-unsaturated carboxylic acid ester copolymers.

7. The golf ball of claim 5, wherein in the copolymer of the intermediate layer, the unsaturated carboxylic acid is acrylic acid or methacrylic acid.

8. The golf ball of claim 6, wherein in the copolymer of the cover, the unsaturated carboxylic acid is acrylic acid or methacrylic acid.

9. The golf ball of claim 1, wherein a material hardness of the intermediate layer is from 45 to 60 on the Shore D hardness scale, and a material hardness of the cover is from 55 to 65 on the Shore D hardness scale.

10. The golf ball of claim 1, wherein the land portion is formed by connecting at least 4,000 curved edge elements.

11. The golf ball of claim 1, wherein a ratio of edge elements having a curvature of not more than 0.40 is at least 70% of curved edge elements forming the land portion.

12. The golf ball of claim 1, wherein the dimples have a surface area occupancy ratio of from 80 to 95%.
